(19) United States
(12) Patent Application Publication
(10) Pub. No.: US 2006/0169073 A1
(43) Pub. Date: Aug. 3, 2006

(54) Propulsion Force Produced by Vibrational Response of Structures

(75) Inventors: Francois Joseph Charette, Canton, MI (US); Louise Francoise Croteau, Canton, MI (US)

Correspondence Address: FRANCOIS CHARETTE, 46324 GAINSBOROUGH DRIVE, CANTON, MI, 48187, US

(73) Assignees: Francois Joseph Charette, Canton, MI (US); Louise Francoise Croteau, Canton, MI (US)

(21) Appl. No.: 10/905,691

(22) Filed: Jan. 17, 2005

(51) Int. Cl. F16H 27/04

(52) U.S. Cl. 74/84 S

(57) ABSTRACT

All structures and mechanical systems possessing mass and elasticity have vibrational responses. The vibrational responses are the result of cyclic exchanges of kinetic and potential energy within the system. These vibrational responses, when properly aligned, phased and conditioned, can be used to create propulsion. There are as many possible embodiments of this invention as there are structures and mechanical systems types. The preferred embodiment disclosed here, to demonstrate the invention, is based on a beam type structure.

### FIELD OF THE INVENTION

This invention relates to the creation of propulsion force required to move vehicles in all types of environments, i.e., gaseous, liquid or vacuum. The propulsion force is created by transferring a portion of a structure's vibrational response energy to the overall system's frame/body. This new invention is self contained and does not require any interaction with the environment to generate the propulsion force.

### BACKGROUND OF THE INVENTION

This invention comes from the need to have simple, easy to use, low cost propulsion system for all kinds of vehicles and more specifically for space vehicles. The widely used current technology, i.e., rocketry, is expensive, difficult and dangerous to operate. Therefore, it can only be utilized by specialized organizations and is not meant for mass usage, which greatly limits outer space development. Alternatives to rocketry have been presented in the prior art. The most common one is inertial propulsion. The majority of inertial propulsion apparatus found in the prior art are based on using centrifugal force combined with the displacement of solid masses along a non symmetric path using gears, variable length radii, electromagnets, etc. in order to create propulsion. Others use liquid instead of solid masses in combination with centrifugal forces. In all cases, it seems that due to efficiency, complexity, feasibility of physical implementations, cost, etc. all the prior art have limited commercial success and outer space development is still not a reality.

The invention presented in this disclosure is original and totally different from the prior art. The propulsion force is not generated by expulsing hot gases or using centrifugal force; instead it is generated by extracting a portion of the forced vibrational response energy of structures. The implementation of this invention is simple, there are few moving parts, and using today's technology fairly easy to implement. These characteristics enable massive production (leads to low cost) of all sizes of propulsion systems that can be implemented in all types of vehicles.

### SUMMARY OF THE INVENTION

This invention creates propulsion force on a body using energy from the vibrational response of structures. The vibrational response is the cyclic, i.e., harmonic, exchange of kinetic and potential energy WITHIN the structure. For example, the vibration of a string on a guitar comes from the cyclic exchange of kinetic and potential energy WITHIN the string itself. The kinetic energy is associated with the velocity of the mass while the potential energy is associated with the stiffness. It is possible to transfer a portion of the kinetic energy to the body on which the structure is attached to and generate propulsion if the vibrating structure is rotated at the same speed that it vibrates.

In the preferred embodiment disclose here, the structure is a beam. This beam is mounted on bearings into a rigid frame. Piezoelectric transducers are glued to the beam and provide the necessary excitation to create the forced vibrational response of the beam. These transducers are required to transfer electrical energy into vibrational energy which is then transferred into propulsion force.

As it is well known in the domain of vibration, as the frequency of the excitation approaches one of the resonance/natural frequencies of a structure, the vibrational response increases considerably. In theory, if there is no damping, at the resonance frequency the response would be infinitely high. Obviously, in practice such infinitely high level is impossible because of damping, shear effects, etc. Nevertheless, the levels at resonance for structures with low damping can be very high compare to off resonance frequency. This implies that the structure's resonance frequencies can be used as “mechanical amplifier”, i.e., small electrical excitation inputs will generate large vibrational response.

The vibrational response of the beam will generate an up and down movement about a reference point of equilibrium, i.e., the beam moves by a certain amount above and below its static position. Propulsion force can be generated when the beam is rotated along its length axis so that the rotation speed matches the vibrational speed. When the rotation speed matches the vibrational speed, then the beam displacement never goes below the reference point equilibrium. The fact that the beam displacement, i.e., acceleration is always in one direction creates a propulsion force.

### BRIEF DESCRIPTION OF THE DRAWINGS

FIG. 1 is an overall view of the preferred embodiment of this invention.

FIG. 2 is a plan view from the right side of the invention.

FIG. 3 illustrates the beam rotation at every 45°. This figure clearly shows that the beam's local system of axes u, v and w rotate with the beam.

FIG. 4 shows the acceleration levels of the beam C.G. along the local axes wand the acceleration levels of the system C.G. along the global axes Z This is for a beam that vibrates only, i.e., it does not rotate.

FIG. 5 presents the case for a beam that vibrates AND rotates at the same speed. The acceleration levels of the beam C.G. and the system C.G. are showed.

FIG. 6 demonstrates the case when two vibrating and rotating structures are attached to the same frame. This combination of two structures into one overall system creates a constant acceleration level, i.e., propulsion force.

### DETAILLED DESCRIPTION OF THE PREFERRED EMBODIMENT

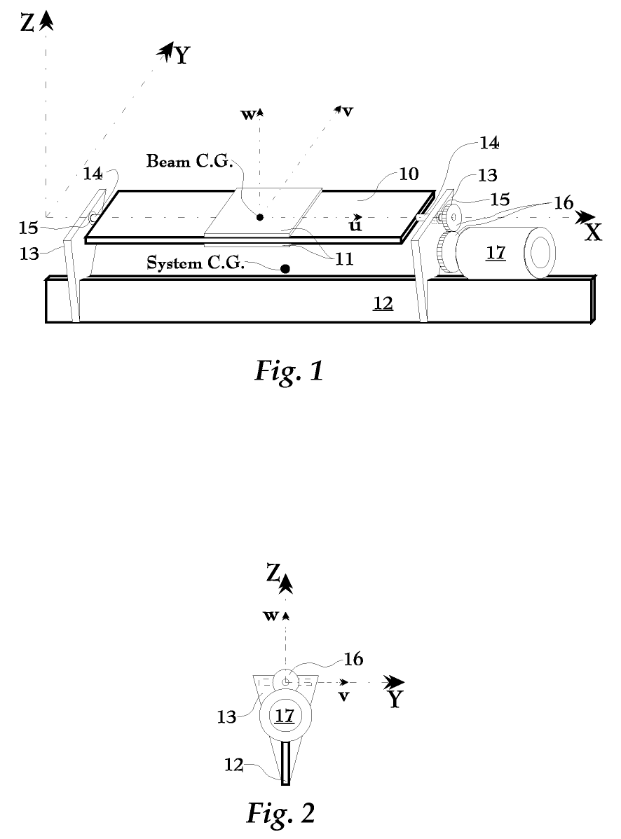

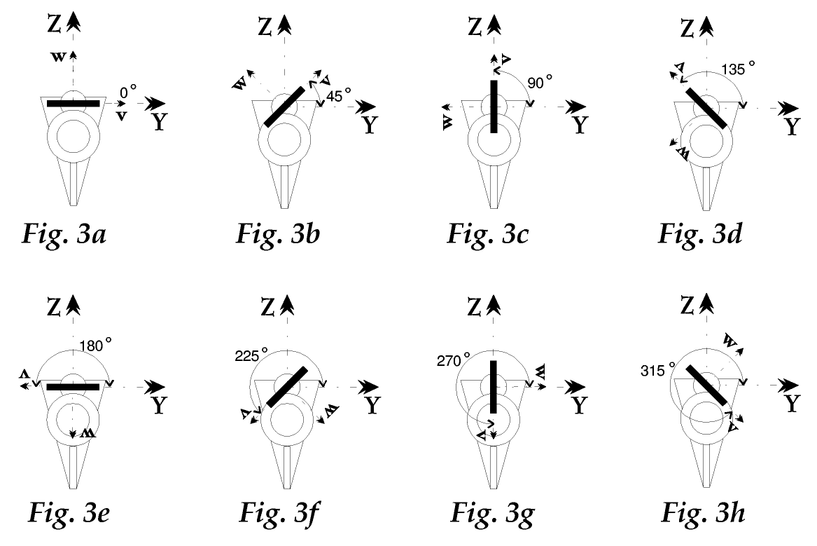

FIG. 1 is a perspective view of the preferred embodiment. It also shows the global system of axes X, Y and Z that is stationary in space and the local system of axes u, v and w that is attached to the beam and rotates as the beam rotates. The preferred embodiment consists of a beam 10 that has two axles 14 at each ends. The axles are mounted on bearings 15 in order to secure the beam to a rigid frame while allowing rotation of the beam. The rigid frame is made of two vertical supports 13 and a base 12 as illustrated in FIG. 1. The beam is symmetric and homogeneous in all directions; therefore the beam center of gravity is at the geometric center of the beam. The origin of the local system of axes u, v and w is also at the geometric center of the beam.

On top and bottom of the beam, there are two piezoelectric plates 11. These plates are used to induce the vibration in the beam. It is well known for somebody skilled in the art that a pair of piezoelectric plates connected out of phase generates flexural vibration to the attached structure. On the right side, the beam axle is attached to a gear system 16 that transfers the rotation generated by a motor 17 to the beam.

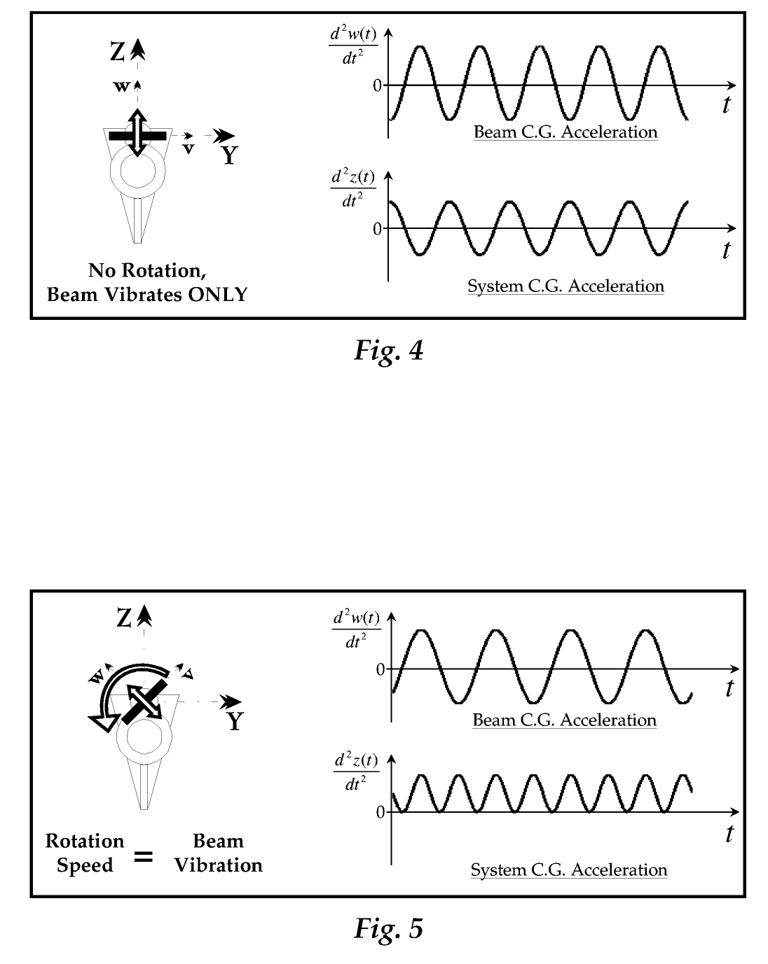

Firstly, consider the case when there is no rotation. When there is no rotation and the piezoelectric transducers induce vibration, the beam center of gravity will move up and down along the Z and waxes following a harmonic motion. A sine function is typically used to describe such motion, w(t)=D·sin(wt). The actual peak amplitude “D” of the up and down displacement will depend on the beam's characteristics, boundary conditions, excitation frequency, excitation amplitude, etc. Velocity and acceleration are associated with this up and down displacement. Anybody skilled in the art knows that for harmonic motion the velocity leads the displacement by 90° while the acceleration leads the displacement by 180°. When the system is suspended, the vibration of the beam's center of gravity will be transmitted to the overall system through the boundary conditions and will cause the system's center of gravity to also move up and down. This implies that not only the beam will be moving up and down but that the whole system will also be moving. The ratio and phase between the harmonic movements of the beam's center of gravity and the system's center of gravity will depend on the ratio of mass between the beam and the system, the boundary conditions characteristics, the damping in the path, etc. FIG. 4 illustrates the acceleration versus time of the beam's center of gravity measured along the w axes and the acceleration versus time of the system's center of gravity measured along the Z axes.

Secondly, consider the case when there is rotation at the same time the beam vibrates; this is the fundamental idea of the invention. Maximum propulsion will be created when the rotation speed is equal to the vibration frequency. This case is shown in FIG. 5. The beam's center of gravity acceleration along the waxes is similar to the previous case, but now due to the rotation, the system's center of gravity acceleration is always positive. As previously mentioned this is the core idea of the invention and it creates a propulsion force. The combination of harmonic motion with rotation creates an acceleration that varies from 0 to a maximum value following a sine square type function, i.e., d²Z(t)/dt²=A·sin²(wt). The associated propulsion force will be the acceleration times the mass of the system, i.e., Newton's second law, F=ma.

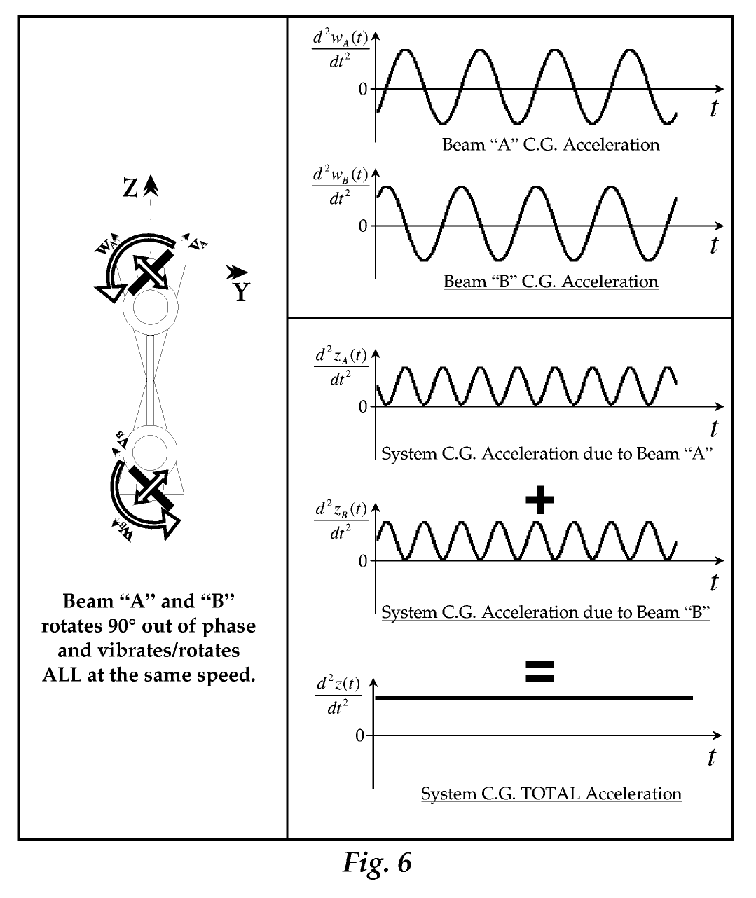

Finally, consider the case when two identical structures are attached to the same frame as showed in FIG. 6. Both structures vibrate and rotate at the same speed, but the structure's rotations are 90° out of phase. The acceleration of the system C.G. due to each structure and the total acceleration are shown. Since each structure generates a A·sin²(wt) acceleration and one of them is 90° out of phase, the sum of the accelerations from each structure on the system C.G. yield a constant acceleration level, i.e., non-variable value, A. This is another advantage of this invention over typical inertial propulsion force based on centrifugal force, which creates a propulsion force that varies in time.

The invention presented in this disclosure is not limited to the preferred embodiment. The invention includes all embodiments that may become apparent after reading this disclosure. Therefore, all implementations that use vibrational responses of structures to generate propulsion force are implicitly included by this disclosure. If inconsistency between the figures presented and the specification exists, the description in the specification takes precedence over the conflicting information found in the figures.

What is claimed is:

1. An innovative invention to create propulsion forces using structure's vibrational responses, at frequencies on or off resonances. The invention comprises:
a) A rigid frame to which the vibrating structure and all the required mechanism for the invention can be attached to.
b) A structure which possesses mass and elasticity.
c) Excitation transducers.
d) Mechanism allowing the rotation of the structure along an axis that is perpendicular to the vibrational response axis.
e) A controller to control and match the vibrational response parameters and the rotational speed.

2. The invention of claim 1 wherein the structure is a beam. The structure could be a string, rod, plate, cylinder, etc. of uniform or variable cross section with arbitrary shape.

3. The invention of claim 1 wherein the structure is a mechanical system having mass and stiffness, such as a mass-spring system of one or multiple degree of freedom, lumped mass on structures, etc.

4. The invention of claim 1 wherein the structure's vibrational response is used as mechanical amplifier, the excitation frequency is on or close to one of the resonant frequencies of the structure.

5. The invention of claim 1 wherein rotation of the structure, or any other means such as special signal generation, is used to match the vibrational response in order to generate a propulsion force.

6. The invention of claim 1 wherein the structure's vibrational response is flexural or of any other type such as axial, torsional, etc.

7. The invention of claim 1 wherein the structure's boundary conditions are clamped-clamped. These boundary conditions could also be pinned-pinned, clamped-free, clamped slide, clamped-pin or any other combinations or types.

8. The invention of claim 1 wherein the structure is excited using piezoelectric transducers. These transducers could also be electric or magnetic based, including transducers such as shakers.

9. The invention of claim 1 wherein a controller ensures the amplitude, phasing and conditioning between the vibrational response and rotational speed to generate propulsion forces. The controller can be mechanically, electronically or digitally based or any combination of these.

10. The invention of claim 1 wherein the frame can be of arbitrary shape and material as long as it accommodates all the requirements of the invention.

11. The invention of claim 1 wherein two or more structures are attached to the same frame to obtain a constant level of propulsion force.

12. The use of this invention for the propulsion of land vehicles, watercrafts, aircrafts and spacecrafts.
